(19) United States
(12) Patent Application Publication
(10) Pub. No.: US 2008/0076689 A1
(43) Pub. Date: Mar. 27, 2008

(54) System using ozonated acetic anhydride to remove photoresist materials

(76) Inventor: Robert R. Matthews, Richmond, CA (US)

Correspondence Address: GORDON & REES LLP, 101 WEST BROADWAY, SUITE 1600, SAN DIEGO, CA, 92101, US

(21) Appl. No.: 11/529,099

(22) Filed: Sep. 27, 2006

(51) Int. Cl. C11D 7/32

(52) U.S. Cl. 510/175

(57) ABSTRACT

A method of removing photoresist materials from a silicon wafer, by exposing a silicon wafer having a photoresist thereon to a solute of Ozonated Acetic Anhydride, thereby removing the photoresist from the silicon wafer.

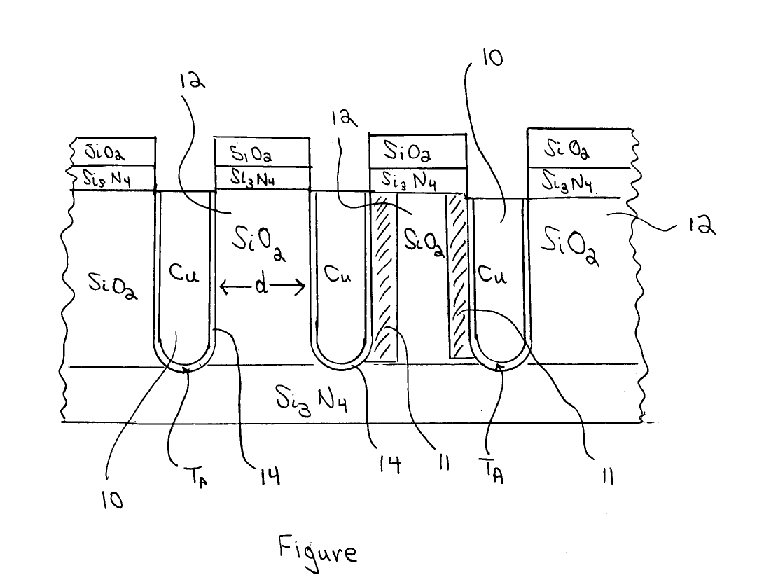

### TECHNICAL FIELD

The present invention is related to methods of removing photoresist material from structures including silicon wafers, flat panel displays, wafer die, solar panels, and III-V semiconductors.

### BACKGROUND OF THE INVENTION

Recently, the semiconductor industry has been moving to 300 mm sized wafers. In addition, the trend in wet processing has been away from batch processing of 50 wafers at one time, to single wafer processing. Two of the reasons for the shift from batch wafer processing to single wafer processing are (1) the desire to process each wafer uniformly, and (2) the reduction in risk of misprocessed or scrapped wafers.

This shift to single wafer processing adds a new requirement to the wet photoresist strip process. The time to process a single wafer should be less than 18 seconds in order to be a viable manufacturing process. Batch processing of fifty wafers, on the other hand, is successful when completed in under 15 minutes. A longer process time translates into reduced wafer throughput and higher manufacturing costs.

In 1997 Legacy Systems, Inc. of Fremont, Calif. was the first company to demonstrate batch processing of organic photoresist removal using an ozonated deionized water solution. By reducing the temperature of the deionized water to 5° C., the ozonated solution was capable of removing photoresist films in 5-10 minutes. The solution removed organic photoresist films with carbon-carbon double bonds (positive Novolak photoresists) and it was compatible with deposited Aluminum and Titanium Nitride films.

The ozonated water solution, called Coldstrip, was a good replacement for either the 130° C. heated sulfuric:hydrogen peroxide solutions, known as Piranha solutions used in processing wafers prior to metal deposition (pre metal applications) or the 70° C. heated solvent solutions comprised of NMP or ethanolamines used in processing wafers with exposed metal films (post metal applications).

With all its good points there were limitations to the ozonated Coldstrip water process. Negative resists with carbon-carbon single bonds were too slowly removed or stripped to be considered for a viable manufacturing process. Also, as the metal systems on semiconductors evolved from Aluminum to Copper, the ozonated water solution would attack any exposed copper film. The copper loss was measured at 300 Å/min at 25° C.

In order to meet the 300 mm wafer throughput requirements (described above), a single wafer ozonated photoresist removal process would have to be significantly faster than any existing ozonated wet photoresist removal process.

The attached FIGURE illustrates a sectional view through a silicon wafer, in which sections of a conductor 10 (which may optionally be Cu) are positioned between sections of an insulator 12 (which may optionally be SiO₂). It is important that current does not seep through insulator 12 and pass between adjacent conductors 10. Therefore, a barrier 14 (which may optionally be Ta) is disposed between adjacent conductors 10 and insulators 12.

The separation distance “d” between adjacent conductors 10 is known as the dielectric wall thickness. In common existing systems, “d” is about 65 nm. However, as silicon wafers become smaller and smaller, distance “d” is decreasing to 45 nm, and eventually it will decrease to 32 nm.

Problems are encountered at such small distances “d”. Specifically, as silicon wafer manufacturing technologies migrate from 45 nm to 32 nm, a common problem is the attack on the interface between the SiO2 insulator 12 and the barrier films 14 under the photoresist. For example, a standard prior art process to remove photoresist at the 45 nm distance “d” silicon wafer is plasma oxygen asher followed by a wet solvent resist stripper. A serious side affect of the plasma process is damage to the insulator 12. These damaged regions of insulator 12 are shown in the FIGURE as shaded regions 11. (For clarity of illustration, damaged regions 11 are only shown at one insulator 12. It is to be understood that such damaged regions are prevalent throughout the silicon wafer at all insulators 12).

At a distance “d” of 45 nm, the damaged regions 11 on either side of insulator 12 are still spaced far enough such that insulator 12 remains intact. In addition, processes exist such that repairs can be made to the fix the damaged regions 11 of insulator 12. But at 32 nm, the sidewall damage is too much to repair. This is due to the fact that, on a 32 nm sidewall thickness, a minimum of 20 nm out of 32 nm or >63% of insulator 12 is typically damaged by the plasma ash process. Note: the forgoing calculation assumes a plasma damaged region 11 having a width of only approximately 10 nm, which is actually quite good in the art.

Clearly, a process that removes photoresist, without compromising the integrity of insulator regions 12 needs to be developed, especially as the distance “d” across insulator 12 decreases.

### SUMMARY OF THE INVENTION

The present invention provides a method of removing photoresist materials from a silicon wafer, by: providing a silicon wafer having a photoresist thereon; exposing the silicon wafer having the photoresist thereon to a solute of ozonated acetic anhydride, thereby removing the photoresist from the silicon wafer.

Optionally, ethylene glycol diacetate or ethylene carbonate can be added to the solute of ozonated acetic anhydride. In addition, hydrofluoric acid can be added in the temperature range of 50-70 C. Optionally as well, acetic acid can be added to the solute of ozonated acetic anhydride. Optionally as well, ozonated acetic anhydride can be followed by a rinse and then an ammonium hydroxide:hydrogen peroxide water mixture can be used. This second step may alternately be done in a separate process tank, or in the same process vessel where the first chemistry is the ozonated acetic anhydride followed by a rinse and then the ammonium hydroxide:hydrogen peroxide:water mixture). The silicon wafer can optionally be heated in an ammonium hydroxide:hydrogen peroxide:water mixture to a temperature in the range of 40-50 C.

An important advantage of the present process is that the use of ozonated acetic anhydride process does not attack the sidewall (i.e.: create damaged regions 11 in insulator 10) or alter the electrical resistivity properties of insulator 10.

A further advantage of the present method is that it is effective removing photoresists from flat panel displays without attacking the sensitive metal film Molybdenum.

A further advantage of the present invention is that the speed of photoresist removal is attractive for dies having one end with very thick photoresist coatings (100-600 microns versus 1-2 micron on semiconductor front end processes. This is due to the fact that the present method has been experimentally determined to reduce the process time from 4-5 hours to 1-2 hours.

### BRIEF DESCRIPTION OF THE DRAWINGS

The FIGURE shows a pictorial cross section of a typical metal Via stack found in a silicon wafer.

### DETAILED DESCRIPTION OF THE DRAWINGS

(a) The Present Method:

The present invention provides a method of removing photoresist materials from a silicon wafer, by: providing a silicon wafer having a photoresist thereon; exposing the silicon wafer having the photoresist thereon to a solute of ozonated acetic anhydride, thereby removing the photoresist from the silicon wafer.

In alternate optional aspects of the method, further chemicals may be added to the Acetic Anhydride:Ozone mixture. Such optional chemicals may assist in removing plasma-damaged resists or other films like BARC (backside-anti-reflective-coatings). Such optional chemicals may include, but are not limited to: Ethylene Glycol Diacetate and Ethylene Carbonate. Such chemicals may optionally be spiked with Hydrofluoric Acid at temperatures in the optional range of 50-70 C. The advantage of this approach is that the acetic anhydride has a low flash point and adding these other chemicals raises the flash point. This is advantageous when the solution is heated.

In another alternate optional aspect of the invention, acetic acid is added to the acetic anhydride. This can be beneficial when removing a thick layer of photoresist around a Tin:Lead (Sn:Pb) solder bump over a thick copper (Cu) stud with a very thin copper seed layer. In this aspect of the invention, both the resist and the very thin copper seed layer can be removed. In optional aspects, a mixture of 50%-50% solution of acetic anhydride and acetic acid can be used. Ozone can be bubbled through the mixture to remove the resist and the copper seed layer while not affecting the Sn:PB:Cu stud. This effect may be due to the small copper etch rate in the acetic acid.

In one approach, the acetic anhydride:acetic acid:ozone solution can be used in one step. Alternately, it can be separated into two steps with the acetic anhydride:ozone solution used to remove the photoresist followed by a separate treatment in acetic acid or acetic acid:ozone used to etch a copper seed layer. This approach is particularly useful when dealing with SnPbCu or SnPbAg studs. Moreover, the process applies even if the stud is another metal alloy combination.

In further optional aspects, the photoresist may be removed with the acetic anhydride:ozone mixture. Then, the thin copper seed layer can be removed in a 40-50 C heated ammonium hydroxide:hydrogen peroxide:water mixture. This second step may possibly be accomplished in as little as 5 seconds. Alternately, the process can be done in one step, thereby reducing the size of the wetstation and the robotics needed to transfer wafers tank to tank and eliminates the additional chemicals and heaters.

It is to be understood that although the present invention is described herein as useful from a single wafer perspective, it is just as effective in batch mode with multiple substrates. As such, the present invention is a scalable process.

(b) Experimental Results:

In an attempt to remove all water molecules and acid functional groups to eliminate galvanic activity and copper etching, ozone was dissolved in Acetic Anhydride. It was unexpectly discovered that organic Photoresist films at 25° C. could be removed very fast. In experiments conducted by the inventor, a 3,300 Å film of 193 nm DUV photoresist was removed in less than 2 seconds! This photoresist strip rate exceeds 90,000 Å/min. This is approximately two orders of magnitude faster than the results achieved with the above described ozonated:water (Coldstrip) solution.

When testing the etch rate of copper films in the acetic anhydride:ozone solution, it was determined Copper had an etch rate of 0.002 um/min or 20 Å/min at 25° C. Etch rates of many other metals (Aluminum, Titanium Nitride, Tungsten, and Chromium) typically used in the semiconductor industry were not affected by the ozonated acetic anhydride solution and metal removal was measured at 0 Å/min at 25° C. Ozonating acetic anhydride at room temperature exceeded the requirements for a single wafer photoresist stripper.

What is claimed is:

1. A method of removing photoresist materials from a silicon wafer, comprising:
providing a silicon wafer having a photoresist thereon;
exposing the silicon wafer having the photoresist thereon to a solute of ozonated acetic anhydride, thereby removing the photoresist from the silicon wafer.

2. The method of claim 1, further comprising:
adding ethylene glycol diacetate to the solute of ozonated acetic anhydride.

3. The method of claim 2, further comprising:
adding hydrofluoric acid in the temperature range of 50-70 C.

4. The method of claim 1, further comprising:
adding ethylene carbonate to the solute of ozonated acetic anhydride.

5. The method of claim 4, further comprising:
adding hydrofluoric acid in the temperature range of 50-70 C.

6. The method of claim 1, further comprising:
adding acetic acid to the solute of ozonated acetic anhydride.

7. The method of claim 6, further comprising:
heating the silicon wafer in an ammonium hydroxide:hydrogen peroxide:water mixture.

8. The method of claim 7, wherein the temperature of the ammonium hydroxide:hydrogen peroxide:water mixture is in the range of 40-50 C.
